(19) United States
(12) Patent Application Publication
(10) Pub. No.: US 2016/0192018 A1
(43) Pub. Date: Jun. 30, 2016

(54) PREVIEWING CONTENT AVAILABLE AT LOCAL MEDIA SOURCES

(71) Applicant: Microsoft Technology Licensing, LLC, Redmond, WA (US)

(72) Inventors: Jeffrey W. Sult, Seattle, WA (US); Nicholas Jie Fang, Redmond, WA (US)

(21) Appl. No.: 14/584,919

(22) Filed: Dec. 29, 2014

(51) Int. Cl. H04N 21/482; H04N 21/462

(52) U.S. Cl. CPC H04N 21/482; H04N 21/4621

(57) ABSTRACT

Examples are disclosed herein that relate to previewing media content available for streaming. One example provides a media consumption device comprising a communications subsystem configured to connect to one or more media sources, a logic device configured to execute instructions, and a storage device having instructions executable by the logic device to, for each of the one or more media sources, send a request for information on a media content item currently being received by the media source and in response, receive a reduced fidelity representation of the media content item being received by the media source, output the reduced fidelity representation of each media content item currently being received by each media source for presentation, receive a user input selecting a selected media content item for viewing, and output the higher fidelity representation of the selected media content item for presentation.

### BACKGROUND

Media content may be consumed via various types of media consumption devices. Some example media consumption devices include, but are not limited to, television displays and mobile devices (e.g. smart phones and tablets). Each of these devices may receive media from a variety of media sources, including but not limited to television-related sources (e.g. television tuners receiving content from cable, broadcast, satellite, etc.) and Internet sources.

### SUMMARY

Examples are disclosed herein that relate to previewing media content currently available at media sources in a local media environment. One example provides a media consumption comprising a communications subsystem configured to connect to the one or more media sources, a logic device configured to execute instructions, and a storage device having instructions executable by the logic device to, for each of the one or more media sources, send a request for information on a media content item currently being received by the media source, in response, receive a reduced fidelity representation of the media content item being received by the media source, and output the reduced fidelity representation of each media content item currently being received by each media source for presentation. The instructions are further executable to receive a user input selecting a selected media content item for viewing, and output the higher fidelity representation of the selected media content item for presentation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an example local media environment.

FIG. 2 shows a block diagram of an example local media environment.

FIGS. 3A and 3B show a flow diagram of an example method of previewing on a media consumption device broadcast media content currently available in a local media environment.

FIGS. 4A-4D illustrate example user interface interactions for previewing streaming media content on a media consumption device.

FIG. 5 shows a block diagram of an example computing system.

### DETAILED DESCRIPTION

As mentioned above, media consumption devices may be enabled to receive media content from different media sources within a local media environment. For example, a mobile device may be configured to receive streaming content via a computer network and also to receive broadcast content via a local television tuner, either by connecting directly to the tuner or by connecting to the tuner through another local network device. This may allow a mobile device user to watch what is currently being played on television in a different room of a house, for example. Such a mobile device also may be configured to allow a user to control the tuner, e.g. to change channels.

However, previewing content available at television tuners via a mobile device may pose challenges. For example, one possible preview method may be to immediately start streaming the content from each channel to the mobile device over a local network as the mobile device user connects to a television tuner and/or changes channels via the mobile device. This may offer the advantage that the mobile device user can see the actual content currently being broadcast and presented. However, this also may strain network and system resources as the user switches from channel to channel. Further, changing channels would be disruptive to any viewers actually watching a television display presenting content being received at that tuner.

Another possible preview method may be to provide a still image or text description of available programs to the mobile device. As more specific examples, key frames (e.g. independently coded frames of compressed media files), series art, and/or text titles of content currently being received at a television tuner may be provided to a mobile device for presentation as previews. However, such previews may be less informative than viewing an actual video segment. In some instances, pre-generated video segments may be available for preview for a content item. However, such previews may not reflect what portion of the content item is playing at that moment, as can be discovered via changing channels and viewing what is actually playing.

Accordingly, examples are disclosed herein that relate to providing previews of media content currently being received at media sources within a local media environment. Briefly, the disclosed examples relate to the provision of dynamically generated lower fidelity streams of content that is currently available at one or more media sources in a local media environment. As will be described in more detail below, the disclosed examples may allow a mobile device user to discover what media is currently available at such media sources, what tuners are currently in use and/or what media sources may be available to re-tune without causing disruption. The previews may be generated based upon the abilities of a mobile device to which the preview is being provided, thereby tailoring the preview experience for the actual device to be used to present the preview. Further, the examples disclosed may provide a user with information regarding whether a TV tuner is already in use by other devices and/or users in the local media environment. As such, the disclosed previews may allow a user to make more informed decisions when selecting media content for previewing and/or streaming

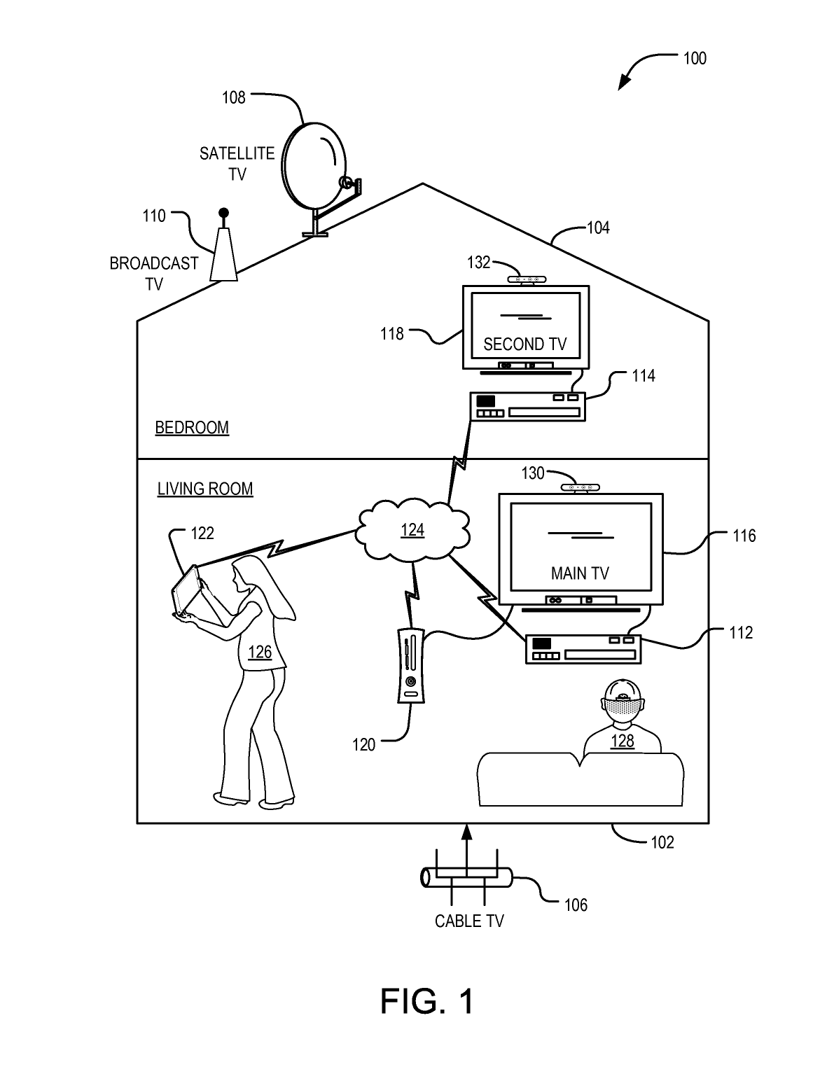

FIG. 1 depicts an example local media environment 100 including a living room 102 and a bedroom 104. Local media environment 100 includes a variety of broadcast media sources, for example, a cable connection 106, a satellite receiver 108, and/or an antenna 110, with which broadcast media content (e.g., cable TV, satellite TV, broadcast TV) may be received. Broadcast signals may be provided by such media sources to one or more TV tuners of local media environment 100. Such tuners also may be referred to herein as media sources. Examples TV tuners are shown in FIGS. 1 at 112 and 114. TV tuners may reside in any of a variety of suitable media rendering or computing devices, including but not limited to a set-top box, a television, a video gaming console, a desktop computer, a laptop computer, and potentially other computing devices. TV tuners may be tuned to channels to allow the presentation of content broadcast over a selected channel. It will be understood that these media sources and types of media content are exemplary in nature and any other suitable broadcast media content may apply, including audio and/or radio content, and Internet Protocol television (IPTV).

TV tuners 112, 114 are depicted as being connected to media consumption devices in the form of main TV 116 in the living room 102 and a secondary TV 118 in the bedroom 104, respectively. Local media environment 100 further includes other media consumption devices, such as an entertainment console 120 (e.g. for presentation of video games, streaming content, etc.) and a mobile device 122 (e.g. a smart phone or tablet computer). The entertainment console 120 (or another computing device) may be configured to receive content from either of tuners 112, 114 and forward the content to mobile device 122 for viewing by user 126.

Further, as explained in more detail below, entertainment console 120 also may be configured to receive and aggregate media content that is currently accessible at media sources in the local media environment 100 (e.g. content available at a channel to which a TV tuner is currently tuned) for provision as lower-fidelity streaming previews to other media consumption devices. A computing device acting or configured to act in such a role is referred to herein as a “media consumption hub device,” in that the device may act both as a media consumption device (e.g. may consume media received from a tuner) and also as a hub to aggregate and distribute content and content previews to other media consumption devices. Entertainment console thus may be referred herein to as “media consumption hub device 120,” and the term “media consumption device” is inclusive of media consumption hub devices. Any suitable device may be used as a media consumption hub device. Examples other than the depicted entertainment console include, but are not limited to, a set-top box capable of receiving and delivering media content to a television, a desktop or laptop computer (or other computing device) configured to receive television signals from a television tuner, and a digital video recording device. In some examples, a media consumption hub device 120 may itself include a TV tuner. A media consumption hub device, such as entertainment console 120, may receive signals from media sources either by direct connection to the media sources (e.g. as depicted for main TV 116) and/or via a network 124, for example a local area network (LAN).

Media consumption hub device 120 also may be configured to receive television control signals from media consumption devices (e.g. device 122), and to provide such control signals to a media source to thereby enable control of the media source by the media consumption devices. As a more specific example, a user 126 of media consumption device 122 may enter a command to change a channel of either of tuners 112 and 114. This command may be received and forwarded by media consumption hub device 120 to effect the channel change, and the content at the new channel may then be received and forwarded to the media consumption device 122. Further, in some examples, media consumption devices 122 may be configured to connect directly to tuners 112, 114 and/or other media sources without the use of a media consumption hub device, thereby allowing previews and content to be received and the media sources to be controlled without the use of a media consumption hub device.

Network 124 may comprise any suitable type of network or combination of networks for devices in a local media environment to communicate. For example, network 124 may include one or more wired and/or wireless networks, for example, and cable, Ethernet, WiFi, WiFi direct, Bluetooth. The network 124 may enable communication between the media consumption hub device 120, the TV tuners 112, 114, media consumption device 122, and any other connected device using any suitable communications protocol, including but not limited to Digital Living Network Alliance (DLNA) protocol, Transmission Control Protocol (TCP), Internet Protocol (IP), Real-time Transport Protocol (RTP), and Real-time Transport Control Protocol (RTCP).

As mentioned above, media consumption hub device 120 may aggregate media content available at media sources in the local entertainment environment, where the media content may be received from a directly connected TV tuner (e.g. to which entertainment console 120 is connected) or through network 124. For example, media consumption hub device 120 may be configured to discover and connect to any TV tuners present in local media environment 100, and send a request to each TV tuner for the media content item currently being received at that TV tuner. As described in more detail below, media consumption hub device 120 may receive a representation of the media content item currently being received by each TV tuner. The representation may be full fidelity or reduced fidelity. Where a full fidelity representation is received, media consumption hub device 120 may form a reduced fidelity version of the media content item from the full fidelity version. Media consumption hub device 120 may then provide the reduced fidelity representations of the media content as previews to one or more other media consumption devices, e.g. media consumption device 122. Thus, user 126 may preview reduced fidelity representations of media content being received at TV tuners 112, 114. The use of reduced fidelity previews may help to reduce the burden on network and/or device resources when sending previews to media consumption device 122 or other media consumption device over a wireless network compared to providing full fidelity previews.

In addition to allowing presentation of previews of media content currently available at television tuners in a local media environment, media consumption device 122 may be configured to allow user selection of a media content item for viewing in a full fidelity representation, e.g. by interacting with a preview to expand the preview. Further, as mentioned above, media consumption device 122 may be configured to allow control of each of TV tuners 112, 114, to tune to different channels. However, a TV tuner that user 126 wishes to control may already be in use by others. For example, user 128 is shown as viewing content from tuner 112 on main TV 116. Thus, if user 126 were to change the current channel received at TV tuner 112, the viewing experience of user 128 may be disrupted.

As such, in addition to the previews, media consumption device 122 may also be configured to provide information regarding whether each previewed media content item is currently being presented on a display or watched, as well as who may be watching. For example, image sensors 130, 132 may capture images of the environment to detect whether any users may be presently viewing media content on main TV 116 and/or second TV 118 via TV tuners 112, 114. Image data and/or other data (e.g. voice data) from sensors 130, 132 also may be used to identify user(s) presently viewing media content. Additionally or alternatively, user account information may be used to determine whether a tuner may be in use by another user. For example, user 128 may be signed into a user account while consuming media content via media consumption hub device 120. Such account information may be used to provide an indication that TV tuner 112 is currently being used by the account holder, while tuner 114 is likely not being used by another person. It will again be appreciated that media consumption device 122 may be configured to connect directly to TV tuner 114 without the user of media consumption hub device 120, and thus may directly receive information regarding whether and what media content item is being presented on main TV 116 by TV tuner 114. Thus, user 126 may be provided with information that can help user 126 choose which television tuner may be used to view what is available on channels other than a currently tuned channel.

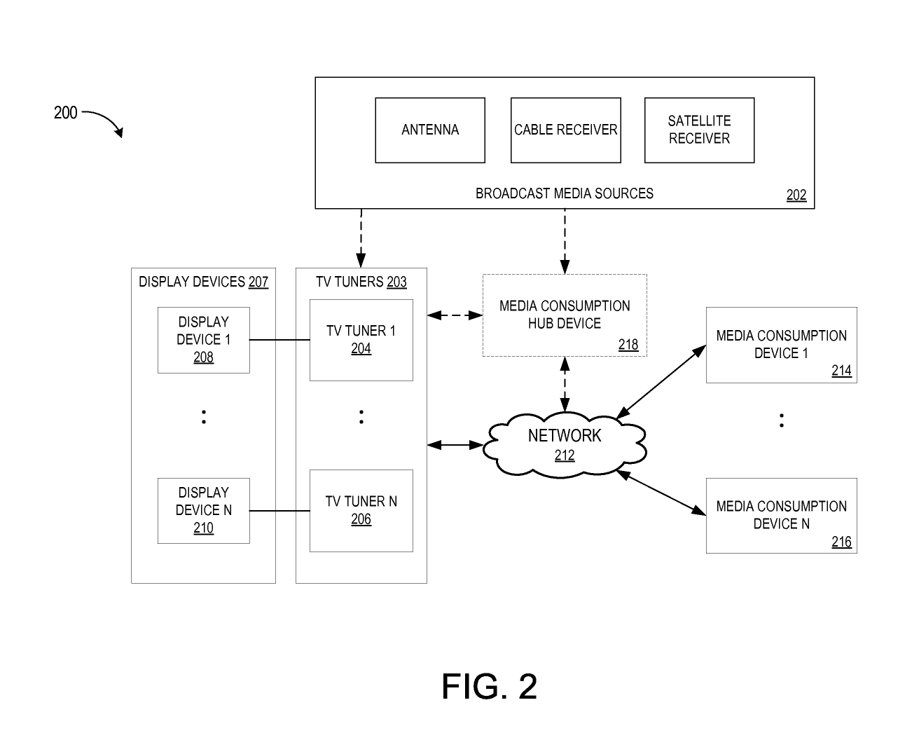

FIG. 2 shows a block diagram illustrating an example local media environment 200. Local media environment 200 includes one or more broadcast media sources 202. Non-limiting examples of broadcast media sources 202 include an antenna, a cable receiver, and/or a satellite receiver. Broadcast media sources 202 may provide broadcast media content to one or local media sources, such as one or more TV tuners 203. Example tuners 203 are shown as TV tuner 1 204 and TV tuner N 206. Each of TV tuner 1 204 through TV tuner N 206 may be coupled to one or more display devices 207, illustrated as display device 1 208 for TV tuner 1 204 and display device N 210 for TV tuner N 206. The TV tuners 203 thus may provide the media content (e.g. TV content) received from broadcast media sources 202 to respective display devices 207 for video display. TV tuners 1 through N may further be connected to a network 212, for example a local area network within a home media environment, for communications with one or more media consumption devices, shown as media consumption device 1 214 and media consumption device N 216. Broadcast media sources 202 also may provide media content to a media consumption hub device 218, which may optionally comprise a TV tuner. Media consumption hub device 218 further may send media content to media consumption devices 1 through N via network 212, receive media source control signals from media consumption devices 214, 216, and forward the control signals to any connected tuners 203.

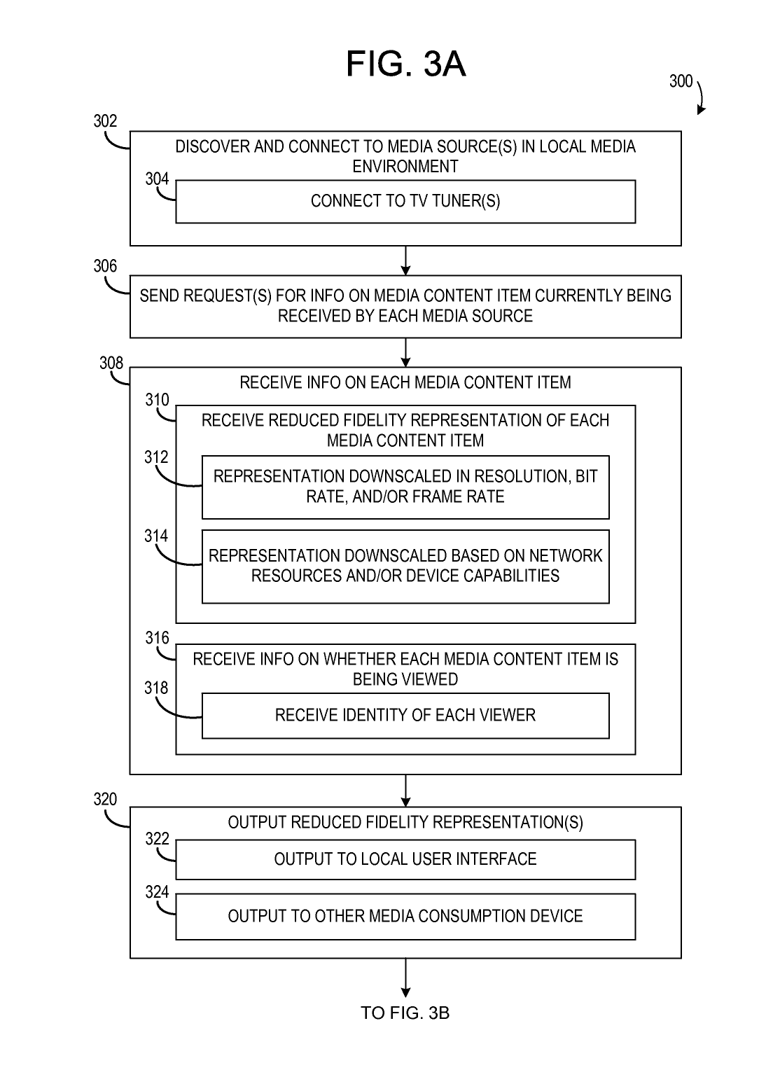

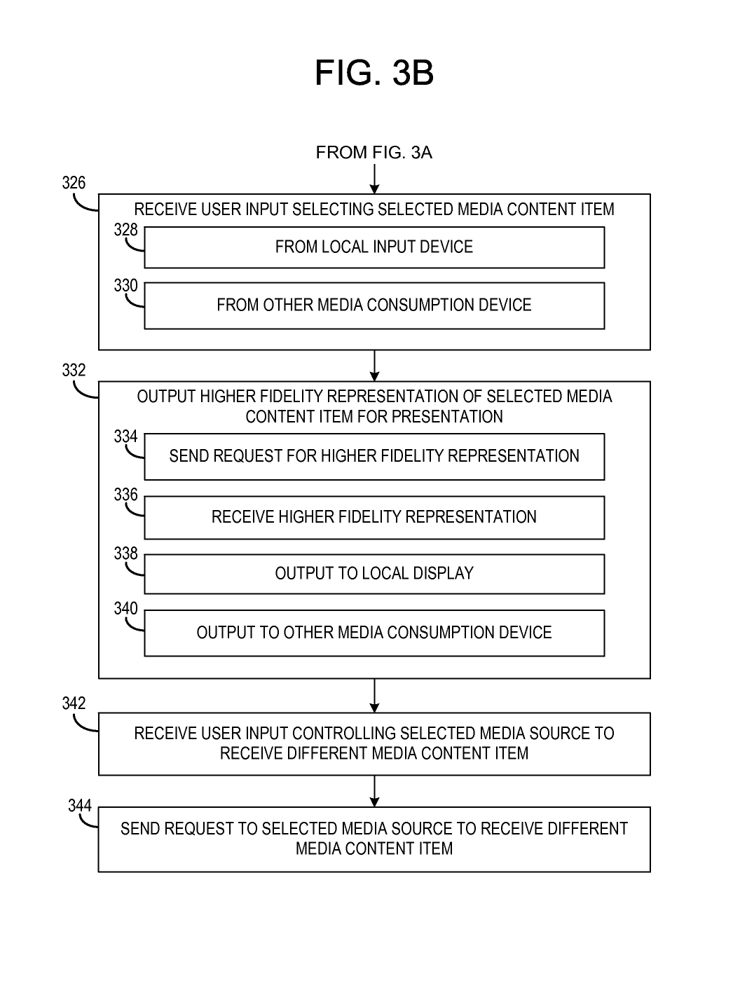

FIGS. 3A-3B shows an example method 300 of previewing broadcast media content on a media consumption device. First regarding FIG. 3A, method 300 comprises, at 302, discovering and connecting to one or more media sources in a local media environment, such as one or more TV tuners, as shown at 304. As described above, a media consumption device may be configured to directly connect to a media source, and/or to connect through a media consumption device hub.

Method 300 further comprises, at 306, sending a request to each media source for information on a media content item currently being received by each media source, and at 308, receiving the information on each media content item. The information received may include, at 310, a reduced fidelity streaming representation of each media content item that represents an actual portion of the content currently being received, as opposed to a pre-generated clip. The fidelity of the content may be reduced in any suitable manner. Examples include, but are not limited to, downscaling of one or more of resolution, bit rate, and frame rate, as shown at 312. Further, a reduced fidelity representation may be downscaled based on currently available network resources and/or the capabilities of the media consumption device (e.g. display specifications, communications capabilities, etc.), as shown at 314. The use of a reduced fidelity representation of a content item currently being received by a tuner as a preview for display on a media consumption device may help to avoid constraining network sources as the user selects and switches between tuners to preview. It will be understood that the downscaling of a fidelity of a representation of a currently available video content item may be performed by a device providing the content item stream to a requesting media consumption device, or by a media consumption hub device prior to forwarding the reduced fidelity representation to another media consumption device.

As mentioned above, in some instances information regarding whether a tuner is currently being used by another viewer may be provided along with the reduced fidelity representation of a content item available at that tuner. Thus, method 300 comprises, at 316, receiving information on whether each media content item is being viewed by any viewers. This information may include information not specific to any viewer (e.g. whether a display device used to present the content is in an on state), or may include an identity of a viewer likely to be watching the content item. Thus, method 300 may include, at 318, receiving an identity of a viewer viewing each media content item. Method 300 further comprises, at 320, outputting the reduced fidelity representation of the media content item currently being received by each media source. The reduced fidelity representation(s) may be output to a local user interface (e.g. to a graphical user interface as one or more video images), as shown at 322, and/or output to another media consumption device, as shown at 324.

Continuing with FIG. 3B, method 300 further comprises, at 326, receiving a user input selecting a selected media content item for viewing. The user input may be received from a local input device, as shown at 328 (e.g. a touch sensitive display on which the reduced fidelity representations are being presented), and/or from another media consumption device (e.g. where it is received at and sent by a media consumption device to a media consumption hub device), as shown at 330. In response to the user selection, method 300 comprises, at 332, outputting a higher fidelity representation of the selected media content item for presentation. This may comprise, for example, sending a request for and receiving the higher fidelity representation, as shown at 334 and 336, respectively. The higher fidelity representation may have a higher resolution, higher bit rate, higher frame rate, and/or be upscaled in any other suitable manner compared to the lower fidelity version. Further, the fidelity of the higher fidelity representation may be based on factors such as network resources and device capabilities. The higher fidelity representation may be output to a local display device at 338, and/or to another media consumption device at 340.

As mentioned above, in some examples a media consumption device may be configured to control a media source, such as by changing a channel of a television tuner. As such, method 300 further comprises, at 342, receiving a user input controlling the selected media source to receive a different media content item, and at 344, sending a request to the selected media source to receive the different media content item. The different media content item may initially be presented as a lower fidelity preview, such that a user of a media consumption device may browse through TV channels to view a lower fidelity representation of currently available content on each channel. Then, upon selection to watch a channel available at a selected tuner, a higher fidelity version of content on the selected channel may be obtained from the selected tuner and provided to the user's media consumption device.

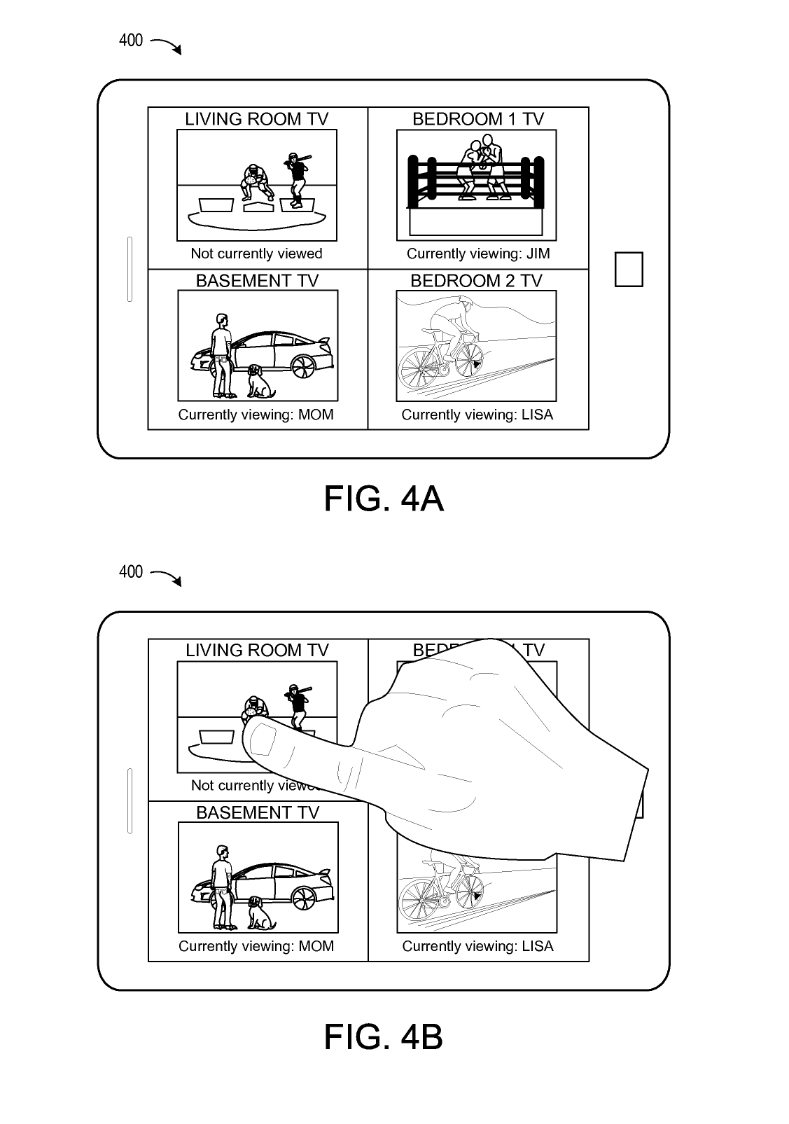

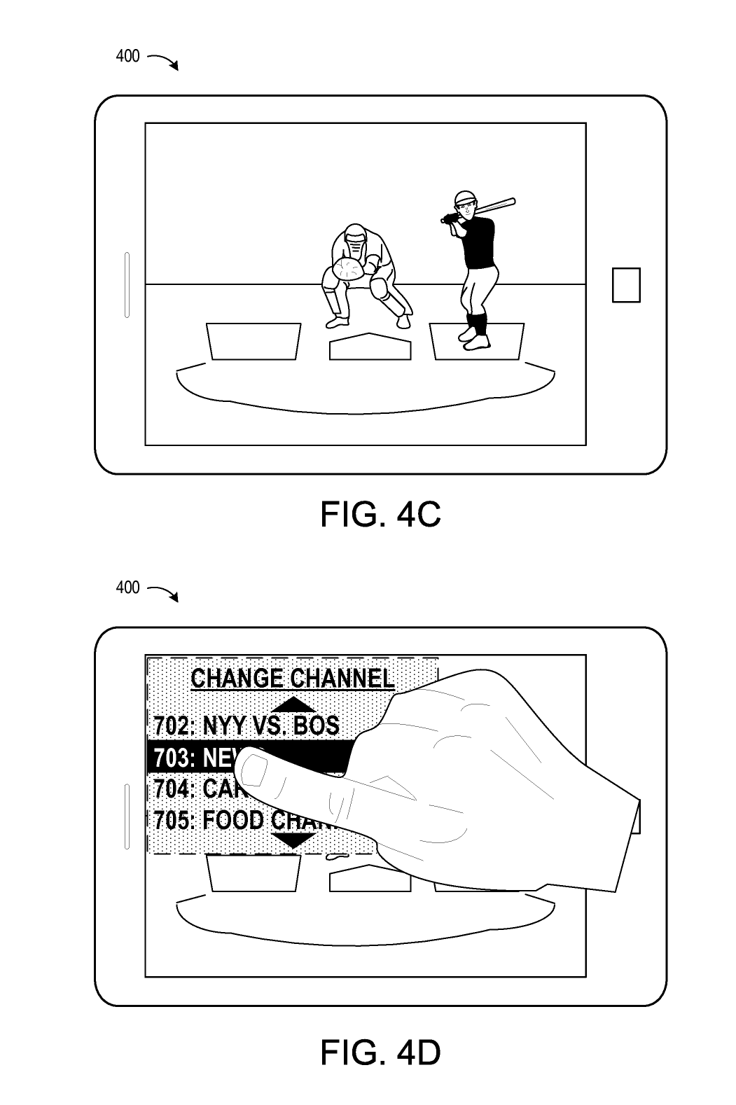

FIGS. 4A-4D show an example user interface (UI) for previewing media content on a media consumption device 400, and also illustrates example interactions therewith. First, FIG. 4A depicts examples of four reduced fidelity previews of media content items currently available at tuners of a living room TV, a first bedroom TV, a second bedroom TV, and a basement TV. In addition to the previews, the UI also shows information regarding whether each media content item is being watched and/or who is currently watching.

Next, FIG. 4B shows a user interacting with media consumption device 400 by selecting the preview of the media content item streaming from the living room TV. FIG. 4C shows the preview expanded to show the media content item streaming from the living room TV as a higher fidelity representation. The user may then continue to view that media content item on media consumption device 400 as long as the media content item is received by the TV tuner of the living room TV. FIG. 4D shows the user interacting with a menu on the UI of media consumption device 400 to select a different media content item for streaming. For example, the user may choose to view the news instead of the baseball game currently being streamed from the living room TV. As such, the TV tuner of the living room TV may then tune to the selected news channel, and a news media content item will then be streamed for viewing. It will be understood that a user may also control the TV tuners and change the media content items while the UI shows multiple media content items in preview mode, for example as shown in FIGS. 4A, 4B.

In some embodiments, the methods and processes described herein may be tied to a computing system of one or more computing devices. In particular, such methods and processes may be implemented as a computer-application program or service, an application-programming interface (API), a library, and/or other computer-program product.

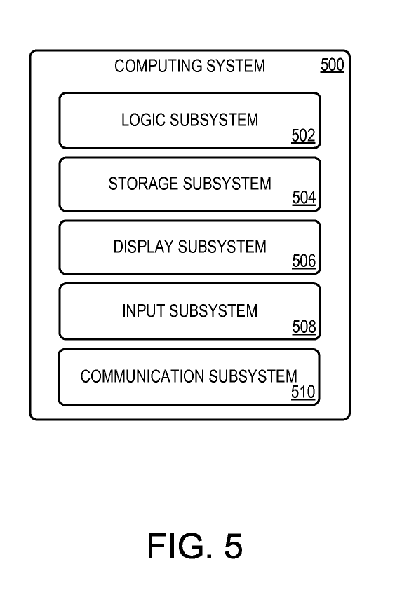

FIG. 5 schematically shows a non-limiting embodiment of a computing system 500 that can enact one or more of the methods and processes described above. For example, computing system 500 may represent any of TV tuners 112, 114, video display devices 116, 118, media consumption hub device 120, and/or media consumption device 122 in FIG. 1. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices. Computing system 500 includes a logic subsystem 502 and a storage subsystem 504. Computing system 500 may optionally include a display subsystem 506, input subsystem 508, communication subsystem 510, and/or other components not shown in FIG. 5.

Logic subsystem 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 502 may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 504 includes one or more physical devices configured to hold instructions executable by the logic machine to implement the methods and processes described herein. When such methods and processes are implemented, the state of storage subsystem 504 may be transformed—e.g., to hold different data.

Storage subsystem 504 may include removable and/or built-in devices. Storage subsystem 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 504 may include volatile, nonvolatile, dynamic, static, read/write, read-only, random-access, sequential-access, location-addressable, file-addressable, and/or content-addressable devices.

It will be appreciated that storage subsystem 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 502 and storage subsystem 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 506 may be used to present a visual representation of data held by storage subsystem 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic subsystem 502 and/or storage subsystem 504 in a shared enclosure, or such display devices may be peripheral display devices.

Input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

Another example provides a media consumption device configured to provide previewing of media content currently being received at one or more media sources in a local media environment, the media consumption device comprising a communications subsystem configured to connect to the one or more media sources, a logic device configured to execute instructions, and a storage device having instructions executable by the logic device to, for each of the one or more media sources, send a request for information on a media content item currently being received by the media source, and in response, receive a reduced fidelity representation of the media content item currently being received by the media source, output the reduced fidelity representation of each media content item currently being received by each media source for presentation, receive a user input selecting a selected media content item for viewing, and output the higher fidelity representation of the selected media content item for presentation. The instructions may additionally or alternatively be executable to send a request for a higher fidelity representation of the selected media content item and to receive the higher fidelity representation of the selected media content item. The media consumption device may additionally or alternatively include a mobile device, wherein the instructions are executable to output the reduced fidelity representation of each media content item currently being received by each media source and to output the higher fidelity representation of the selected media content item by outputting each of the reduced fidelity representation and the higher fidelity representation to a display screen of the mobile device. The communications subsystem may additionally or alternatively be configured to connect to one or more other media consumption devices, and wherein the instructions are executable to output the reduced fidelity representation of each media content item currently being received by each media source and to output the higher fidelity representation of the selected media content item by outputting each of the reduced fidelity representation and the higher fidelity representation to a selected other media consumption device. In this example, the one or more media sources may additionally or alternatively include a plurality of media sources. Additionally or alternatively, each media source may include a television tuner in the local media environment. The instructions may additionally or alternatively be executable to receive information regarding whether the media content item is currently being viewed by a viewer. The reduced fidelity representation of each media content item may additionally or alternatively comprise a representation modified in one or more of resolution, bit rate, and frame rate. The reduced fidelity representation of each media content item may additionally or alternatively comprise a representation modified based on one or more of network resources and capabilities of the media consumption device.

Another example provides, on a media consumption device, a method for previewing media content currently being received at one or more media sources in a local media environment, the method comprising connecting to the one or more media sources, for each of the one or more media sources, sending a request for information on a media content item currently being received by the media source, and in response, receiving a reduced fidelity representation of the media content item currently being received by the media source, outputting to a user interface the reduced fidelity representation of each media content item currently being received by each media source, receiving a user input via the user interface selecting a selected media content item for viewing, sending a request for a higher fidelity representation of the selected media content item, receiving the higher fidelity representation of the selected media content item and outputting to the user interface the higher fidelity representation of the selected media content item. In this example, the media consumption device may additionally or alternatively comprise a mobile device, and wherein the user interface is presented on a display screen of the mobile device. The method may additionally or alternatively include connecting to the one or more media sources by connecting to a plurality of media sources. Further, each media source may additionally or alternatively comprise a television tuner in the local media environment. The method may additionally or alternatively include receiving information regarding whether each media content item is currently being viewed by a viewer. The reduced fidelity representation of each media content item may additionally or alternatively comprise a representation downscaled in one or more of resolution, bit rate, and frame rate. The reduced fidelity representation of each media content item may additionally or alternatively comprise a representation modified based on one or more of network resources and capabilities of the media consumption device.

Another example provides a media presentation system configured to aggregate information regarding media content currently being received by media sources in a local media environment, the media presentation system comprising a communications subsystem configured to connect to one or more media consumption devices and one or more media sources in the local media environment, a logic device configured to execute instructions, and a storage device comprising instructions executable by the logic subsystem to connect to the one or more media sources, for each of the one or more media sources, send a request for information on a media content item currently being received by the media source, and in response, receive a reduced fidelity representation of the media content item currently being received by the media source, receive a request for the information on each media content item currently being received by each media source from a requesting media consumption device, output to the requesting media consumption device the reduced fidelity representation of each media content item currently being received by each media source, receive a user input from the requesting media consumption device selecting a selected media content item for viewing, and output to the requesting media consumption device a higher fidelity representation of the selected media content item. The instructions may additionally or alternatively be executable to send a request for the higher fidelity representation of the selected media content item, and receive the higher fidelity representation. The one or more media sources may additionally or alternatively comprise a television tuner. The instructions may additionally or alternatively be executable to receive information regarding whether each media content item is currently being viewed by a viewer.

The subject matter of the present disclosure includes all novel and nonobvious combinations and subcombinations of the various processes, systems and configurations, and other features, functions, acts, and/or properties disclosed herein, as well as any and all equivalents thereof.

1. A media consumption device configured to provide previewing of media content currently being received at a plurality of media sources in a local media environment, each media source comprising a television tuner, the media consumption device comprising:
a communications subsystem configured to connect to each of the plurality of media sources;
a logic device configured to execute instructions; and
a storage device having instructions executable by the logic device to
for each of the plurality of media sources,
send a request for information on a media content item currently being received by the television tuner, and
in response, receive a reduced fidelity representation of the media content item currently being received by the television tuner;
output the reduced fidelity representation of each media content item currently being received by each television tuner for presentation;
receive a user input selecting a selected media content item for viewing;
in response, receive a higher fidelity representation of the selected media content item; and
output the higher fidelity representation of the selected media content item for presentation.

2. The media consumption device of claim 1, wherein the instructions are further executable to send a request for the higher fidelity representation of the selected media content item after receiving the user input selecting the selected media content item for viewing.

3. The media consumption device of claim 1, wherein the media consumption device comprises a mobile device, and wherein the instructions are executable to output the reduced fidelity representation of each media content item currently being received by each television tuner and to output the higher fidelity representation of the selected media content item by outputting each of the reduced fidelity representation and the higher fidelity representation to a display screen of the mobile device.

4. The media consumption device of claim 1, wherein the communications subsystem is further configured to connect to one or more other media consumption devices, and wherein the instructions are executable to output the reduced fidelity representation of each media content item currently being received by each television tuner and to output the higher fidelity representation of the selected media content item by outputting each of the reduced fidelity representation and the higher fidelity representation to a selected other media consumption device.

5. The media consumption device of claim 1, wherein the one or more media sources comprises a plurality of media sources.

6. (canceled)

7. The media consumption device of claim 1, wherein the instructions are further executable to receive information regarding whether the media content item is currently being viewed by a viewer.

8. The media consumption device of claim 1, wherein the reduced fidelity representation of each media content item comprises a representation modified in one or more of resolution, bit rate, and frame rate.

9. The media consumption device of claim 1, wherein the reduced fidelity representation of each media content item comprises a representation modified based on one or more of network resources and capabilities of the media consumption device.

10. On a media consumption device, a method for previewing media content currently being received at a plurality of media sources in a local media environment, each media source comprising a television tuner, the method comprising:
connecting to each of the plurality of media sources;
for each of the plurality of media sources,
sending a request for information on a media content item currently being received by the television tuner, and
in response, receiving a reduced fidelity representation of the media content item currently being received by the television tuner;
outputting to a user interface the reduced fidelity representation of each media content item currently being received by each television tuner;
receiving a user input via the user interface selecting a selected media content item for viewing;
sending a request for a higher fidelity representation of the selected media content item;
receiving the higher fidelity representation of the selected media content item; and
outputting to the user interface the higher fidelity representation of the selected media content item.

11. The method of claim 10, wherein the media consumption device comprises a mobile device, and wherein the user interface is presented on a display screen of the mobile device.

12. The method of claim 10, wherein connecting to the one or more media sources comprises connecting to a plurality of media sources.

13. (canceled)

14. The method of claim 10, further comprising receiving information regarding whether each media content item is currently being viewed by a viewer.

15. The method of claim 10, wherein the reduced fidelity representation of each media content item comprises a representation modified in one or more of resolution, bit rate, and frame rate.

16. The method of claim 10, wherein the reduced fidelity representation of each media content item comprises a representation modified based on one or more of network resources and capabilities of the media consumption device.

17. A media presentation system configured to aggregate information regarding media content currently being received by media sources in a local media environment, each media source comprising a television tuner, the media presentation system comprising:
a communications subsystem configured to connect to one or more media consumption devices and a plurality of media sources in the local media environment;
a logic device configured to execute instructions; and
a storage device comprising instructions executable by the logic subsystem to connect to each of the plurality of media sources;
for each of the plurality of media sources,
send a request for information on a media content item currently being received by the television tuner, and
in response, receive a reduced fidelity representation of the media content item currently being received by the television tuner;
receive a request for the information on each media content item currently being received by each television tuner from a requesting media consumption device;
output to the requesting media consumption device the reduced fidelity representation of each media content item currently being received by each television tuner;
receive a user input from the requesting media consumption device selecting a selected media content item for viewing;
in response, receive a higher fidelity representation of the selected media content item; and
output to the requesting media consumption device a higher fidelity representation of the selected media content item.

18. The media presentation system of claim 17, wherein the instructions are further executable to send a request for the higher fidelity representation of the selected media content item, and receive the higher fidelity representation.

19. (canceled)

20. The media presentation system of claim 17, wherein the instructions are further executable to receive information regarding whether each media content item is currently being viewed by a viewer.
